(19) United States
(12) Patent Application Publication
(10) Pub. No.: US 2026/0245525 A1
(43) Pub. Date: Aug. 20, 2026

(54) DISPLAY DEVICE INCLUDING A DEMULTIPLEXER CIRCUIT AND ELECTRONIC DEVICE

(71) Applicant: Samsung Display Co., Ltd., Yongin-si (KR)

(72) Inventors: SUBIN KIM, Yongin-si (KR); HYUNCHANG KIM, Yongin-si (KR); SE-BYUNG CHAE, Yongin-si (KR)

(21) Appl. No.: 19/380,750

(22) Filed: Nov. 5, 2025

(30) Foreign Application Priority Data
Feb. 20, 2025 (KR) 10-2025-0022176

(51) Int. Cl. G09G 3/3275; G09G 3/32

(52) U.S. Cl. CPC G09G 3/3275; G09G 3/32; G09G 2300/0426; G09G 2310/0275; G09G 2310/0291; G09G 2310/0297

(57) ABSTRACT

A display device includes: a display panel including a plurality of data lines, and a plurality of pixels connected to the plurality of data lines; a data driver comp including rising an output channel to output a data voltage; and a demultiplexer circuit to selectively connect the output channel to two or more data lines among the plurality of data lines in response to first and second switching signals. The output channel includes: a source output buffer to output the data voltage; and a zero control circuit to selectively apply a zero control resistor to an output load of the source output buffer in response to a zero control enable signal and a source output enable signal.

### CROSS-REFERENCE TO RELATED APPLICATION

The present application claims priority to and the benefit of Korean Patent Application No. 10-2025-0022176, filed on February 20, 2025, in the Korean Intellectual Property Office, the entire disclosure of which is incorporated by reference herein.

### BACKGROUND

### 1. Field

Aspects of embodiments of the present disclosure relate to a display device including a demultiplexer circuit, and an electronic device including the display device.

### 2. Description of the Related Art

To reduce the number of output channels of a data driver, a demultiplexing driving technique has been developed. According to the demultiplexing driving technique, each output channel may be alternately connected to two or more data lines using a demultiplexer circuit. The demultiplexer circuit may sequentially connect each output channel to two or more data lines within each horizontal time in a time-division manner. Accordingly, in a display device implementing the demultiplexing driving technique, the number of output channels may be less than the number of the data lines.

The above information disclosed in this Background section is for enhancement of understanding of the background of the present disclosure, and therefore, it may contain information that does not constitute prior art.

### SUMMARY

In a display device implementing the demultiplexing driving technique, when a source output buffer within the output channel is not connected to a data line, an output load of the source output buffer may decrease, which may reduce a phase margin of the source output buffer and increase a risk of oscillation of the source output buffer.

Some embodiments of the present disclosure may be directed to a display device including a data driver having improved stability.

Some embodiments of the present disclosure may be directed to an electronic device including the display device.

According to one or more embodiments of the present disclosure, a display device includes: a display panel including a plurality of data lines, and a plurality of pixels connected to the plurality of data lines; a data driver including an output channel configured to output a data voltage; and a demultiplexer circuit configured to selectively connect the output channel to two or more data lines among the plurality of data lines in response to first and second switching signals. The output channel includes: a source output buffer configured to output the data voltage; and a zero control circuit configured to selectively apply a zero control resistor to an output load of the source output buffer in response to a zero control enable signal and a source output enable signal.

In an embodiment, the zero control circuit may be configured to apply the zero control resistor to the output load of the source output buffer during a period in which the output channel is not connected to the two or more data lines.

In an embodiment, the zero control circuit may be configured to shift a zero of the source output buffer to a lower frequency during a period in which the output channel is not connected to the two or more data lines.

In an embodiment, the zero control circuit may include: a source output enable transistor connected between an output terminal of the source output buffer and the demultiplexer circuit, and configured to be turned on in response to the source output enable signal; the zero control resistor connected to the demultiplexer circuit; and a zero control enable transistor connected in series with the zero control resistor between the output terminal of the source output buffer and the demultiplexer circuit, and configured to be turned on in response to the zero control enable signal.

In an embodiment, the plurality of pixels may be located in a plurality of pixel rows, and a horizontal time for each of the plurality of pixel rows may include: a first period in which both the first switching signal and the second switching signal have an off-level; a second period in which the first switching signal has an on-level and the second switching signal has the off-level; a third period in which both the first switching signal and the second switching signal have the off-level; a fourth period in which the first switching signal has the off-level and the second switching signal has the on-level; and a fifth period in which both the first switching signal and the second switching signal have the off-level.

In an embodiment, the plurality of data lines may include a first data line and a second data line. The demultiplexer circuit may include: a first switch configured to connect the output channel to the first data line in response to the first switching signal having the on-level in the second period; and a second switch configured to connect the output channel to the second data line in response to the second switching signal having the on-level in the fourth period. The demultiplexer circuit may be configured to not connect the output channel to the first and second data lines in the first, third, and fifth periods.

In an embodiment, the zero control enable signal may have an on-level in the first, second, third, fourth, and fifth periods. The source output enable signal may have an off-level in the first, third, and fifth periods, and may have the on-level in the second and fourth periods.

In an embodiment, in the second and fourth periods, the zero control enable transistor may be configured to be turned on, and the zero control resistor may be configured to not be applied to the output load of the source output buffer. In the first, third, and fifth periods, the zero control enable transistor may be configured to be turned off, and the zero control resistor may be configured to be applied to the output load of the source output buffer.

In an embodiment, the source output buffer may include: a first amplifier; a second amplifier including an input terminal connected to an output terminal of the first amplifier; and a first capacitor connected between the input terminal of the second amplifier and an output terminal of the second amplifier.

In an embodiment, the source output buffer may be configured to control an impedance of the source output buffer in response to a capacitance control signal.

In an embodiment, the source output buffer may be configured to increase the impedance of the source output buffer during a period in which the output channel is not connected to the two or more data lines.

In an embodiment, the source output buffer may be configured to shift a dominant pole of the source output buffer to a lower frequency during a period in which the output channel is not connected to the two or more data lines.

In an embodiment, the source output buffer may include: a first amplifier; a second amplifier including an input terminal connected to an output terminal of the first amplifier; a first capacitor connected between the input terminal of the second amplifier and an output terminal of the second amplifier; a second capacitor connected to the output terminal of the second amplifier; and a capacitance control transistor connected in series with the second capacitor between the input terminal of the second amplifier and the output terminal of the second amplifier, and configured to be turned on in response to the capacitance control signal.

In an embodiment, the plurality of pixels may be located in a plurality of pixel rows, and a horizontal time for each of the plurality of pixel rows may include: a first period in which both the first switching signal and the second switching signal have an off-level; a second period in which the first switching signal has an on-level and the second switching signal has the off-level; a third period in which both the first switching signal and the second switching signal have the off-level; a fourth period in which the first switching signal has the off-level and the second switching signal has the on-level; and a fifth period in which both the first switching signal and the second switching signal have the off-level. The capacitance control signal may have the on-level in the first, third, and fifth periods, and may have the off-level in the second and fourth periods. The capacitance control transistor may be configured to connect the second capacitor to the input terminal of the second amplifier in response to the capacitance control signal having the on-level in the first, third, and fifth periods.

According to one or more embodiments of the present disclosure, a display device includes: a display panel including a plurality of data lines, and a plurality of pixels connected to the plurality of data lines; a data driver including an output channel configured to output a data voltage; and a demultiplexer circuit configured to selectively connect the output channel to two or more data lines among the plurality of data lines in response to first and second switching signals. The output channel includes a source output buffer configured to output the data voltage, and the source output buffer is configured to control an impedance of the source output buffer in response to a capacitance control signal.

In an embodiment, the source output buffer may be configured to increase the impedance of the source output buffer during a period in which the output channel is not connected to the two or more data lines.

In an embodiment, the source output buffer may be configured to shift a dominant pole of the source output buffer to a lower frequency during a period in which the output channel is not connected to the two or more data lines.

In an embodiment, the source output buffer may include: a first amplifier; a second amplifier including an input terminal connected to an output terminal of the first amplifier; a first capacitor connected between the input terminal of the second amplifier and an output terminal of the second amplifier; a second capacitor connected to the output terminal of the second amplifier; and a capacitance control transistor connected in series with the second capacitor between the input terminal of the second amplifier and the output terminal of the second amplifier, and configured to be turned on in response to the capacitance control signal.

In an embodiment, the output channel may further include: a zero control circuit configured to selectively apply a zero control resistor to an output load of the source output buffer in response to a zero control enable signal and a source output enable signal, and the zero control circuit may include: a source output enable transistor connected between an output terminal of the source output buffer and the demultiplexer circuit, and configured to be turned on in response to the source output enable signal; the zero control resistor connected to the demultiplexer circuit; and a zero control enable transistor connected in series with the zero control resistor between the output terminal of the source output buffer and the demultiplexer circuit, and configured to be turned on in response to the zero control enable signal.

According to one or more embodiments of the present disclosure, an electronic device includes: a processor configured to provide input image data; and a display device configured to receive the input image data from the processor, and display an image based on the input image data, the display device including: a display panel including a plurality of data lines, and a plurality of pixels connected to the plurality of data lines; a data driver including an output channel configured to output a data voltage; and a demultiplexer circuit configured to selectively connect the output channel to two or more data lines among the plurality of data lines in response to first and second switching signals. The output channel includes: a source output buffer configured to output the data voltage; and a zero control circuit configured to selectively apply a zero control resistor to an output load of the source output buffer in response to a zero control enable signal and a source output enable signal. The source output buffer is configured to control an impedance of the source output buffer in response to a capacitance control signal.

According to some embodiments of the present disclosure, in a display device and an electronic device, an output channel of a data driver may include a zero control circuit that selectively applies a zero control resistor to an output load of a source output buffer included in the output channel in response to a zero control enable signal and a source output enable signal. Accordingly, a phase margin of the source output buffer and stability of the data driver may be improved without increasing a settling time of the source output buffer.

According to some embodiments of the present disclosure, in a display device and an electronic device, the source output buffer included in the output channel of the data driver may control an impedance of the source output buffer in response to a capacitance control signal. Accordingly, the phase margin of the source output buffer and the stability of the data driver may be further improved without increasing the settling time of the source output buffer.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a block diagram illustrating a display device according to some embodiments.

FIG. 2 is a diagram illustrating an example of a display panel and a demultiplexer circuit according to some embodiments.

FIG. 3A is a circuit diagram illustrating an example of an output load model of a source output buffer in a display device that does not include a zero control circuit.

FIG. 3B is a timing diagram illustrating an example of an output load of a source output buffer in a display device that does not include a zero control circuit.

FIG. 4 is a circuit diagram illustrating an example of an output channel of a data driver according to some embodiments.

FIG. 5 is a timing diagram illustrating an example of an output load of a source output buffer in a display device according to some embodiments.

FIG. 6 is a diagram illustrating an example of a phase margin of a source output buffer in a display device that does not include a zero control circuit, and an example of a phase margin of a source output buffer in a display device according to some embodiments.

FIG. 7 is a block diagram illustrating a display device according to some embodiments.

FIG. 8 is a circuit diagram illustrating an example of an output channel of a data driver according to some embodiments.

FIG. 9 is a timing diagram illustrating an example of an impedance of a source output buffer in a display device according to some embodiments.

FIG. 10 is a diagram illustrating an example of a phase margin of a source output buffer in a display device that does not include a zero control circuit, and an example of a phase margin of a source output buffer in a display device according to some embodiments.

FIG. 11 is a block diagram illustrating a display device according to some embodiments.

FIG. 12 is a circuit diagram illustrating an example of an output channel of a data driver according to some embodiments.

FIG. 13 is a timing diagram illustrating an example of an output load and an impedance of a source output buffer in a display device according to some embodiments.

FIG. 14 is a diagram illustrating an example of a phase margin of a source output buffer in a display device that does not include a zero control circuit, and an example of a phase margin of a source output buffer in a display device according to some embodiments.

FIG. 15 is a block diagram illustrating an electronic device according to some embodiments.

FIG. 16 is a schematic diagram illustrating various electronic devices according to some embodiments.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being "electrically connected" to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” "includes," "including," "has," "have," and "having," when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression "A and/or B" denotes A, B, or A and B. Expressions such as “at least one of,” when preceding a list of elements, modify the entire list of elements and do not modify the individual elements of the list. For example, the expression "at least one of a, b, or c," “at least one of a, b, and c,” and “at least one selected from the group consisting of a, b, and c” indicates only a, only b, only c, both a and b, both a and c, both b and c, all of a, b, and c, or variations thereof.

As used herein, the term "substantially," "about," and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms "use," "using," and "used" may be considered synonymous with the terms "utilize," "utilizing," and "utilized," respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

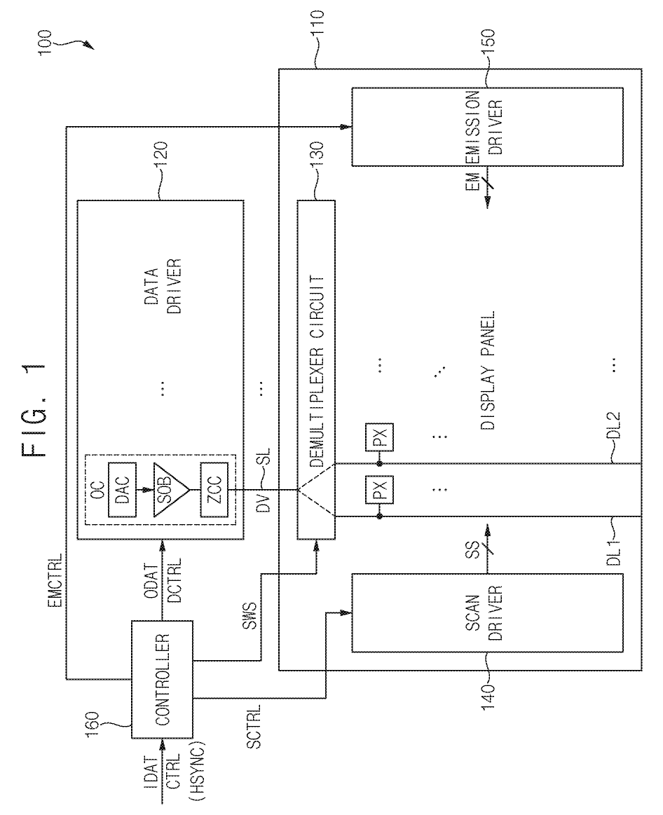

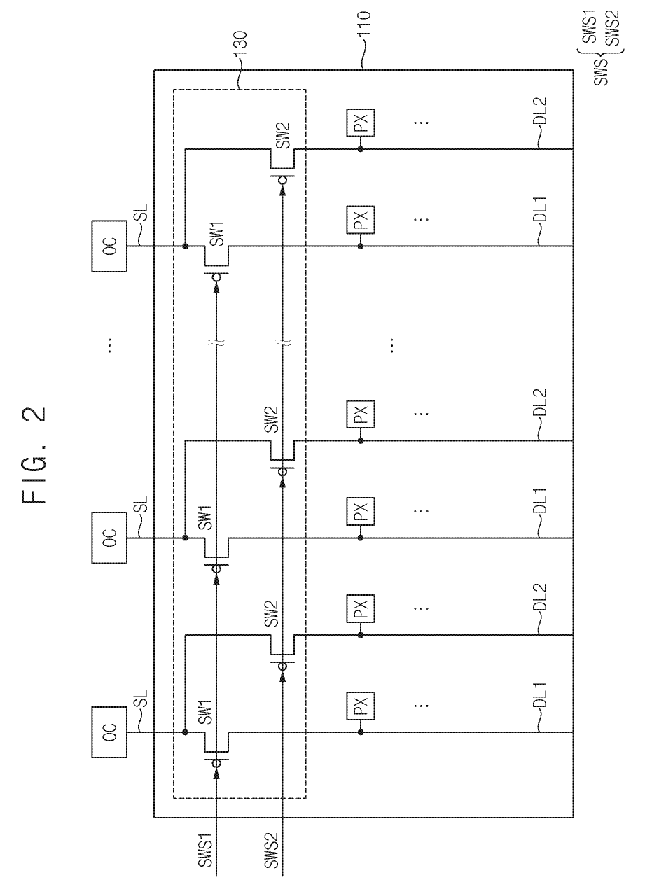

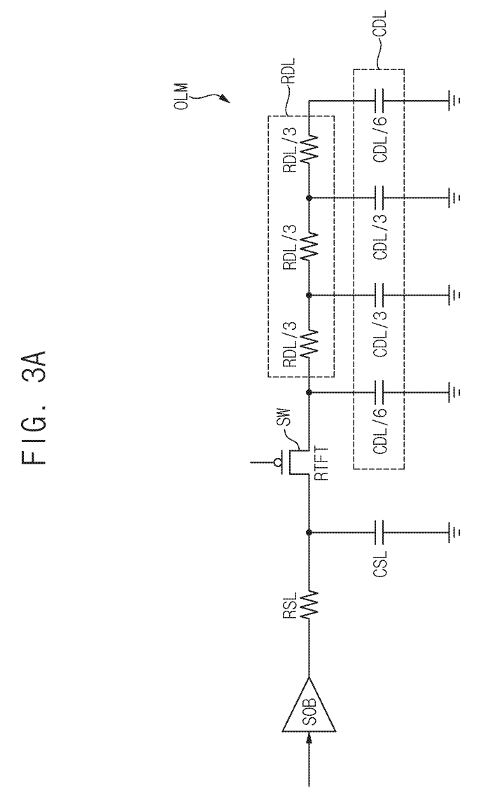

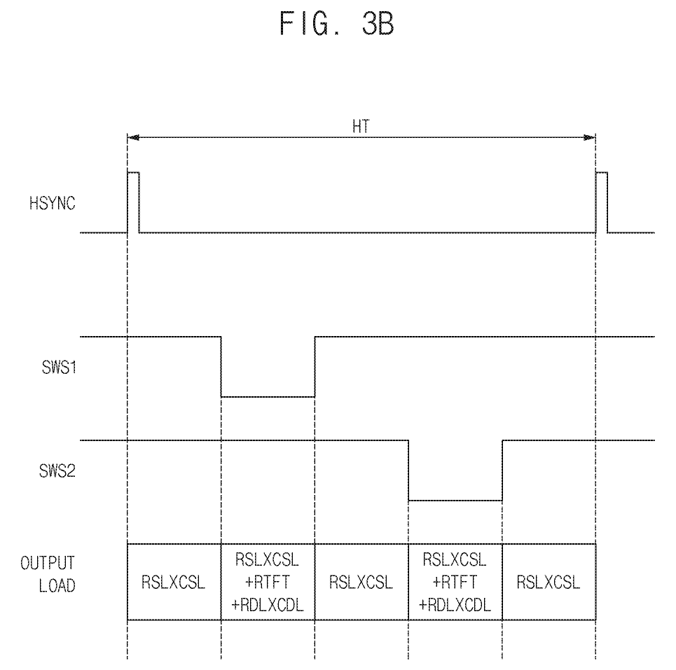

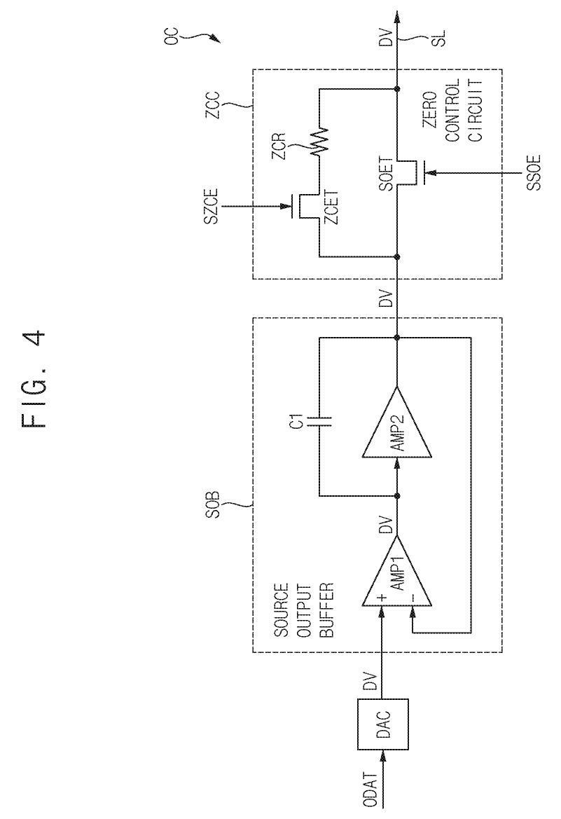

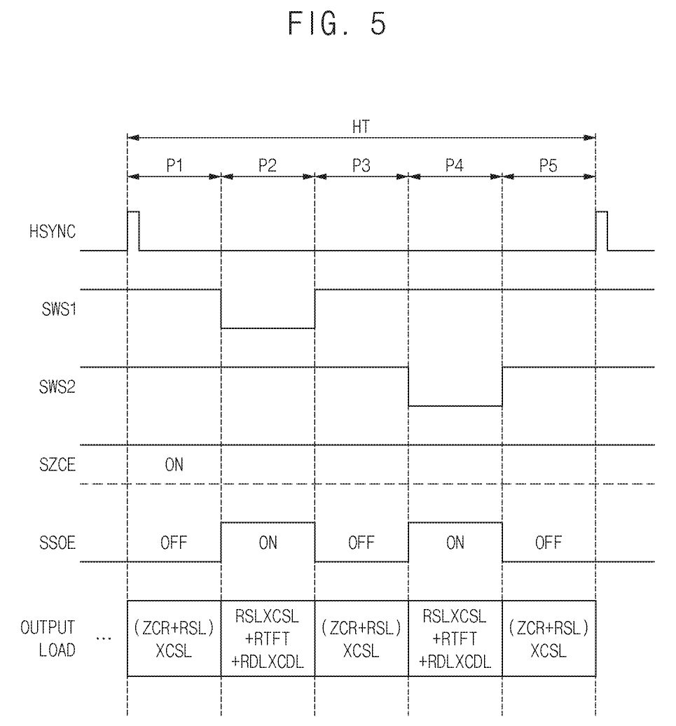

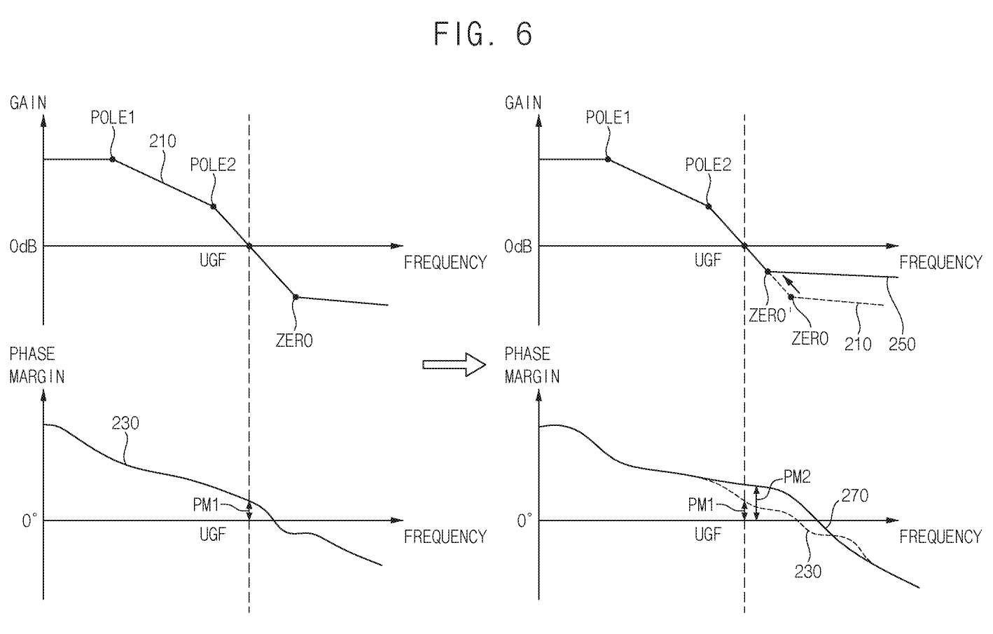

FIG. 1 is a block diagram illustrating a display device according to some embodiments. FIG. 2 is a diagram illustrating an example of a display panel and a demultiplexer circuit according to some embodiments. FIG. 3A is a circuit diagram illustrating an example of an output load model of a source output buffer in a display device that does not include a zero control circuit. FIG. 3B is a timing diagram illustrating an example of an output load of a source output buffer in a display device that does not include a zero control circuit. FIG. 4 is a circuit diagram illustrating an example of an output channel of a data driver according to some embodiments. FIG. 5 is a timing diagram illustrating an example of an output load of a source output buffer in a display device according to some embodiments. FIG. 6 is a diagram illustrating an example of a phase margin of a source output buffer in a display device that does not include a zero control circuit, and an example of a phase margin of a source output buffer in a display device according to some embodiments.

Referring to FIG. 1, a display device 100 according to some embodiments may include a display panel 110. The display panel 110 may include a plurality of data lines DL1 and DL2, and a plurality of pixels PX connected to the plurality of data lines DL1 and DL2. The display device 100 may further include a data driver 120 that provides data voltages DV to the plurality of pixels PX, and a demultiplexer circuit 130 connected between the data driver 120 and the plurality of data lines DL1 and DL2. In some embodiments, as illustrated in FIG. 1, the display device 100 may further include a scan driver 140 that provides scan signals SS to the plurality of pixels PX, an emission driver 150 that provides emission signals EM to the plurality of pixels PX, and a controller 160 that controls the data driver 120, the demultiplexer circuit 130, the scan driver 140, and the emission driver 150.

The display panel 110 may include the plurality of data lines DL1 and DL2, a plurality of scan lines, a plurality of emission lines, and the plurality of pixels PX connected to the plurality of data lines DL1 and DL2, the plurality of scan lines, and the plurality of emission lines. In some embodiments, each pixel PX may include a light-emitting element, and the display panel 110 may be a light-emitting display panel. The light-emitting element may be, but is not limited to, an organic light-emitting diode (“OLED”). For example, the light-emitting element may be a nano light-emitting diode (“nano-LED”), a quantum dot (“QD”) light-emitting diode, a micro light-emitting diode, an inorganic light-emitting diode, or any other suitable kind of light-emitting element. However, the display panel 110 is not limited to the light-emitting display panel, and may be any suitable kind of display panel.

The data driver 120 may generate the data voltages DV based on output image data ODAT and a data control signal DCTRL received from the controller 160, and may provide the data voltages DV to the plurality of pixels PX through a plurality of source output lines SL, the demultiplexer circuit 130, and the plurality of data lines DL1 and DL2. In some embodiments, the data control signal DCTRL may include, but is not limited to, an output data enable signal, a horizontal start signal, and a load signal. The data driver 120 may include a plurality of output channels OC that generates and outputs the data voltages DV. Each output channel OC may include, but is not limited to, a digital-to-analog converter DAC that converts the output image data ODAT for the pixel PX into the data voltage DV, a source output buffer SOB that outputs the data voltage DV, and a zero control circuit ZCC that selectively applies (e.g., adds or connects) a zero control resistor (e.g., a zero control resistance) to an output load of the source output buffer SOB. In some embodiments, the data driver 120 may further include a shift register that generates sampling signals, and each output channel OC may further include, but is not limited to, a sampling latch that samples the output image data ODAT in response to a corresponding one of the sampling signals, a holding latch that stores the output image data ODAT sampled by the sampling latch, and/or the like. In some embodiments, the data driver 120 and the controller 160 may be implemented as a single integrated circuit, and the single integrated circuit may be referred to as a timing controller embedded data driver (“TED”) integrated circuit. In other embodiments, the data driver 120 and the controller 160 may be implemented as separate integrated circuits from each other.

The demultiplexer circuit 130 may selectively connect the plurality of source output lines SL connected to the plurality of output channels OC to the plurality of data lines DL1 and DL2 of the display panel 110 in response to switching signals SWS. The demultiplexer circuit 130 may perform a demultiplexing operation that selectively connects each output channel OC to two or more data lines DL1 and DL2 in response to the switching signals SWS. Thus, the number of the plurality of output channels OC of the data driver 120 may be less than the number of the plurality of data lines DL1 and DL2 of the display panel 110, and a size of the data driver 120 may be reduced compared with a size of a data driver of a display device that does not include the demultiplexer circuit 130. In some embodiments, the demultiplexer circuit 130 may perform a 1:2 demultiplexing operation that selectively connects each output channel OC to two data lines DL1 and DL2. In other embodiments, the demultiplexer circuit 130 may perform a 1:N demultiplexing operation that selectively connects each output channel OC to N data lines, where N is an integer greater than or equal to three. In some embodiments, as illustrated in FIG. 1, the demultiplexer circuit 130 may be integrated with or formed in the display panel 110. In other embodiments, the demultiplexer circuit 130 may be included in the data driver 120, or may be implemented in an integrated circuit that includes the data driver 120.

In some embodiments, to selectively connect each output channel OC (or the source output line SL connected to each output channel OC) to two or more data lines DL1 and DL2, as illustrated in FIG. 2, the demultiplexer circuit 130 may include a plurality of first switches SW1 that connects the plurality of output channels OC (or the plurality of source output lines SL connected to the plurality of output channels OC) to first data lines DL1 among the plurality of data lines DL1 and DL2 in response to a first switching signal SWS1, and a plurality of second switches SW2 that connects the plurality of output channels OC to second data lines DL2 among the plurality of data lines DL1 and DL2 in response to a second switching signal SWS2. While the first switching signal SWS1 has an on-level (e.g., a low level), the first switch SW1 may connect the source output line SL of the output channel OC to the first data line DL1, and the output channel OC may provide the data voltage DV to the pixel PX connected to the first data line DL1. While the second switching signal SWS2 has the on-level, the second switch SW2 may connect the source output line SL of the output channel OC to the second data line DL2, and the output channel OC may provide the data voltage DV to the pixel PX connected to the second data line DL2. Further, while both of the first and second switching signals SWS1 and SWS2 have an off-level (e.g., a high level), the source output line SL of each output channel OC may not be connected to any of the first and second data lines DL1 and DL2. In some embodiments, as illustrated in FIG. 2, the plurality of first switches SW1 and the plurality of second switches SW2 may be implemented with, but are not limited to, P-type metal-oxide-semiconductor (“PMOS”) transistors. In other embodiments, the plurality of first switches SW1 and the plurality of second switches SW2 may be implemented with N-type metal-oxide-semiconductor (“NMOS”) transistors.

Referring to FIG. 1, the scan driver 140 may generate the scan signals SS based on a scan control signal SCTRL received from the controller 160, and may provide the scan signals SS to the plurality of pixels PX through the plurality of scan lines. In some embodiments, the scan control signal SCTRL may include, but is not limited to, a scan start signal and a scan clock signal. In some embodiments, the scan driver 140 may be integrated with or formed in the display panel 110. In other embodiments, the scan driver 140 may be implemented with one or more integrated circuits.

The emission driver 150 may generate the emission signals EM based on an emission control signal EMCTRL received from the controller 160, and may provide the emission signals EM to the plurality of pixels PX through the plurality of emission lines. In some embodiments, the emission control signal EMCTRL may include, but is not limited to, an emission start signal and an emission clock signal. In some embodiments, the emission driver 150 may be integrated with or formed in the display panel 110. In other embodiments, the emission driver 150 may be implemented with one or more integrated circuits.

The controller 160 (e.g., a timing controller) may receive input image data IDAT and a control signal CTRL from an external processor (e.g., an application processor (“AP”), a graphics processing unit (“GPU”), or a graphics card). In some embodiments, the control signal CTRL may include a horizontal synchronization signal HSYNC that defines a horizontal time allocated to each pixel row of the display panel 110. The horizontal time may be a time allocated to one row of the plurality of pixels PX in the display panel 110, and may correspond to a time obtained by dividing one frame period by the number of pixel rows in the display panel 110. The control signal CTRL may include, but is not limited to, a vertical synchronization signal, an input data enable signal, a master clock signal, and/or the like. The controller 150 may generate the output image data ODAT, the data control signal DCTRL, the scan control signal SCTRL, the emission control signal EMCTRL, and the switching signals SWS based on the input image data IDAT and the control signal CTRL. The controller 150 may control the data driver 120 by providing the output image data ODAT and the data control signal DCTRL to the data driver 120. The controller 150 may control the scan driver 140 by providing the scan control signal SCTRL to the scan driver 140. The controller 150 may control the emission driver 150 by providing the emission control signal EMCTRL to the emission driver 150. The controller 150 may control the demultiplexer circuit 130 by providing the switching signals SWS to the demultiplexer circuit 130.

In a display device that does not include the zero control circuit ZCC, during a period in which the output channel OC is not connected to the data lines DL1 and DL2, an output load of the source output buffer SOB may be reduced, a phase margin of the source output buffer SOB may be reduced, and a possibility of an oscillation of the source output buffer SOB may be increased. FIG. 3A illustrates an example of an output load model OLM of the source output buffer SOB in a display device that does not include the zero control circuit ZCC, and FIG. 3B illustrates an example of a horizontal synchronization signal HSYNC, a first switching signal SWS1, a second switching signal SWS2, and an output load OUTPUT LOAD of the source output buffer SOB in the display device that does not include the zero control circuit ZCC. For example, as illustrated in FIGS. 3A and 3B, the horizontal synchronization signal HSYNC may define a horizontal time HT allocated to each pixel row of the display panel 110, and the first switching signal SWS1 and the second switching signal SWS2 may sequentially have an on-level (e.g., a low level) within the horizontal time HT. During a period in which the first switching signal SWS1 or the second switching signal SWS2 has the on-level, an output terminal of the source output buffer SOB may be connected to a source output line resistor RSL of the source output line SL, a source output line capacitor CSL of the source output line SL, a turn-on resistor RTFT of a switch SW (e.g., the first switch SW1 or the second switch SW2) of the demultiplexer circuit 130, a data line resistor RDL of a data line (e.g., the first data line DL1 or the second data line DL2), and a data line capacitor CDL of the data line. In the output load model OLM, the data line resistor RDL may be modeled as three resistors RDL/3, and the data line capacitor CDL may be modeled as four capacitors CDL/6 and CDL/3 connected to terminals of the three resistors RDL/3, but is not limited thereto. Thus, during the period when the first switching signal SWS1 or the second switching signal SWS2 has the on-level, the output load OUTPUT LOAD of the source output buffer SOB may be expressed as “RSLXCSL + RTFT + RDLXCDL”. However, during a period in which both of the first and second switching signals SWS1 and SWS2 have an off-level (e.g., a high level), the switch SW of the demultiplexer circuit 130 may be turned off, and the output terminal of the source output buffer SOB may be connected only to the source output line resistor RSL and the source output line capacitor CSL. Thus, during the period in which both of the first and second switching signals SWS1 and SWS2 have the off-level, the output load OUTPUT LOAD of the source output buffer SOB may be reduced to “RSLXCSL”. Further, if the output load OUTPUT LOAD of the source output buffer SOB is reduced, a phase margin of the source output buffer SOB may be reduced, a possibility of an oscillation of the source output buffer SOB may be increased, and a stability of the data driver 120 may be reduced.

According to some embodiments, however, in the display device 100, to increase the phase margin of the source output buffer SOB and to improve the stability of the data driver 120, each output channel OC of the data driver 120 may include the zero control circuit ZCC that applies (e.g., adds or connects) the zero control resistor (e.g., the zero control resistance) ZCR to the output load of the source output buffer SOB during the period in which each output channel OC of the data driver 120 is not connected to the data lines DL1 and DL2.

In some embodiments, as illustrated in FIG. 4, the output channel OC may include the digital-to-analog converter DAC that converts the output image data ODAT into the data voltage DV, the source output buffer SOB that outputs the data voltage DV, and the zero control circuit ZCC that selectively applies (e.g., adds or connects) the zero control resistor ZCR to the output load of the source output buffer SOB.

The source output buffer SOB may include a first amplifier AMP1, a second amplifier AMP2 including an input terminal connected to an output terminal of the first amplifier AMP1, and a first capacitor C1 connected between the input terminal of the second amplifier AMP2 and an output terminal of the second amplifier AMP2. The first amplifier AMP1 may include a non-inverting input terminal that receives the data voltage DV from the digital-to-analog converter DAC, and an inverting input terminal connected to the output terminal of the second amplifier AMP2. Although FIG. 4 illustrates an example of the source output buffer SOB, the source output buffer SOB is not limited to the example of FIG. 4, and may have any suitable configuration.

The zero control circuit ZCC may selectively apply (e.g., add or connect) the zero control resistor ZCR to the output load of the source output buffer SOB in response to a zero control enable signal SZCE and a source output enable signal SSOE. In this case, the zero control circuit ZCC may include a source output enable transistor SOET, the zero control resistor ZCR, and a zero control enable transistor ZCET. The source output enable transistor SOET may be connected between an output terminal of the source output buffer SOB (e.g., the output terminal of the second amplifier AMP2) and the demultiplexer circuit 130 (e.g., the source output line SL connected to the demultiplexer circuit 130), and may be turned on in response to the source output enable signal SSOE. The zero control resistor ZCR and the zero control enable transistor ZCET may be connected in series with each other between the output terminal of the source output buffer SOB (e.g., the output terminal of the second amplifier AMP2) and the demultiplexer circuit 130 (e.g., the source output line SL connected to the demultiplexer circuit 130). For example, as illustrated in FIG. 4, the zero control enable transistor ZCET may be connected between the output terminal of the source output buffer SOB and the zero control resistor ZCR, and the zero control resistor ZCR may be connected between the zero control enable transistor ZCET and the source output line SL. The zero control enable transistor ZCET may be turned on in response to the zero control enable signal SZCE.

As illustrated in FIG. 5, the horizontal time HT defined by the horizontal synchronization signal HSYNC may include a first period P1 in which both the first and second switching signals SWS1 and SWS2 have an off-level (e.g., a high level), a second period P2 in which the first switching signal SWS1 has an on-level (e.g., a low level) and the second switching signal SWS2 has the off-level, a third period P3 in which both the first and second switching signals SWS1 and SWS2 have the off-level, a fourth period P4 in which the first switching signal SWS1 has the off-level and the second switching signal SWS2 has the on-level, and a fifth period P5 in which both the first and second switching signals SWS1 and SWS2 have the off-level. In the second period P2, the first switch SW1 may connect the output channel OC to the first data line DL1 in response to the first switching signal SWS1 having the on-level. In the fourth period P4, the second switch SW2 may connect the output channel OC to the second data line DL2 in response to the second switching signal SWS2 having the on-level. In the first, third, and fifth periods P1, P3, and P5, the demultiplexer circuit 130 may not connect the output channel OC to the plurality of data lines DL1 and DL2.

The zero control enable signal SZCE has an on-level ON (e.g., a high level) in all of the first, second, third, fourth, and fifth periods P1, P2, P3, P4, and P5, and thus, the zero control enable transistor ZCET may be turned on in all of the first, second, third, fourth, and fifth periods P1, P2, P3, P4, and P5. In some embodiments, the zero control enable signal SZCE and the zero control enable transistor ZCET may be used to enable or disable a function of the zero control circuit ZCC. For example, when the zero control enable signal SZCE has the on-level ON, the zero control enable transistor ZCET may be turned on, the zero control resistor ZCR may be connected to the output terminal of the source output buffer SOB, and the zero control circuit ZCC may be enabled. However, when the zero control enable signal SZCE has an off-level (e.g., a low level), the zero control enable transistor ZCET may be turned off, the zero control resistor ZCR may not be connected to the output terminal of the source output buffer SOB, and the zero control circuit ZCC may be disabled.

The source output enable signal SSOE may have an off-level OFF (e.g., a low level) in the first, third, and fifth periods P1, P3, and P5, and an on-level ON (e.g., a high level) in the second and fourth periods P2 and P4. In the second and fourth periods P2 and P4, the source output enable transistor SOET may be turned on in response to the source output enable signal SSOE having the on-level ON. Thus, in the second and fourth periods P2 and P4, the source output buffer SOB may provide the data voltage DV to the pixel PX through the source output enable transistor SOET, the source output line SL, the switch SW (e.g., the first switch SW1 or the second switch SW2) of the demultiplexer circuit 130, and the data line (e.g., the first data line DL1 or the second data line DL2). Because the source output enable transistor SOET having no or almost no resistance is connected in parallel with the zero control resistor ZCR between the output terminal of the source output buffer SOB and the source output line SL, the zero control resistor ZCR may be ignored, and the zero control resistor ZCR (e.g., the zero control resistance) may not be applied (e.g., added or connected) to the output load OUTPUT LOAD of the source output buffer SOB. Thus, in the second and fourth periods P2 and P4 in which the data voltage DV is provided to the pixel PX, the output load OUTPUT LOAD of the source output buffer SOB may be expressed as “RSLXCSL + RTFT + RDLXCDL”, which is the same or substantially the same as the output load OUTPUT LOAD illustrated in FIG. 3B in the display device that does not include the zero control circuit ZCC. Accordingly, in the second and fourth periods P2 and P4 in which the data voltage DV is provided to the pixel PX, a settling time of the source output buffer SOB may not be increased.

In the first, third, and fifth periods P1, P3, and P5, the source output enable transistor SOET may be turned off in response to the source output enable signal SSOE having the off-level OFF, and the first and second switches SW1 and SW2 of the demultiplexer circuit 130 may be turned off in response to the first and second switching signals SWS1 and SWS2. Thus, in the first, third, and fifth periods P1, P3, and P5, the output terminal of the source output buffer SOB may be connected to the zero control resistor ZCR and the source output line SL through the zero control enable transistor ZCET, and the zero control resistor ZCR (e.g., the zero control resistance) may be applied (e.g., added or connected) to the output load OUTPUT LOAD of the source output buffer SOB. Accordingly, in the first, third, and fifth periods P1, P3, and P5 in which the output channel OC is not connected to the data lines DL1 and DL2, the output load OUTPUT LOAD of the source output buffer SOB may be increased from the output load OUTPUT LOAD illustrated in FIG. 3B in the display device that does not include the zero control circuit ZCC (e.g., “RSLXCSL” to “(ZCR+RSL)XCSL”). Thus, in the first, third, and fifth periods P1, P3, and P5 in which the output channel OC is not connected to the data lines DL1 and DL2, the zero control circuit ZCC may shift a zero (e.g., a zero point) of the source output buffer SOB to a lower frequency, and may increase the phase margin of the source output buffer SOB.

FIG. 6 illustrates, in the first, third, and fifth periods P1, P3, and P5 in which the output channel OC is not connected to the data lines DL1 and DL2, a graph 210 of a gain of a source output buffer SOB according to a frequency in the display device that does not include the zero control circuit ZCC, a graph 230 of a phase margin of the source output buffer SOB according to the frequency in the display device that does not include the zero control circuit ZCC, a graph 250 of a gain of the source output buffer SOB according to the frequency in the display device 100 according to some embodiments, and a graph 270 of a phase margin of the source output buffer SOB according to the frequency in the display device 100 according to some embodiments. The source output buffer SOB of the display device 100 according to some embodiments may have a first pole (e.g., a first pole point) POLE1 and a second pole (e.g., a second pole point) POLE2 that are the same or substantially the same as those of the source output buffer SOB of the display device that does not include the zero control circuit ZCC. However, in the display device 100 according to some embodiments, in the first, third, and fifth periods P1, P3, and P5 in which the output channel OC is not connected to the data lines DL1 and DL2, the zero control resistor ZCR may be applied (e.g., added or connected) to the output load OUTPUT LOAD of the source output buffer SOB, and thus, the zero ZERO’ of the source output buffer SOB of the display device 100 according to some embodiments may be shifted toward the lower frequency compared with that of the zero ZERO of the source output buffer SOB of the display device that does not include the zero control circuit ZCC. Accordingly, at a frequency at which the gain of the source output buffer SOB is about 0 dB (e.g., at a unit gain frequency UGF), a phase margin PM2 of the source output buffer SOB of the display device 100 according to some embodiments may be increased compared with a phase margin PM1 of the source output buffer SOB of the display device that does not include the zero control circuit ZCC. Therefore, in the display device 100 according to some embodiments, because the source output buffer SOB has the increased phase margin PM2, a possibility of an oscillation of the source output buffer SOB may be reduced, and the stability of the data driver 120 may be improved.

As described above, in the display device 100 according to some embodiments, the output channel OC of the data driver 120 may include the zero control circuit ZCC that selectively applies the zero control resistor ZCR to the output load OUTPUT LOAD of the source output buffer SOB in response to the zero control enable signal SZCE and the source output enable signal SSOE. Accordingly, without increasing the settling time of the source output buffer SOB, the phase margin of the source output buffer SOB may be improved, the possibility of the oscillation of the source output buffer SOB may be reduced, and the stability of the data driver 120 may be improved.

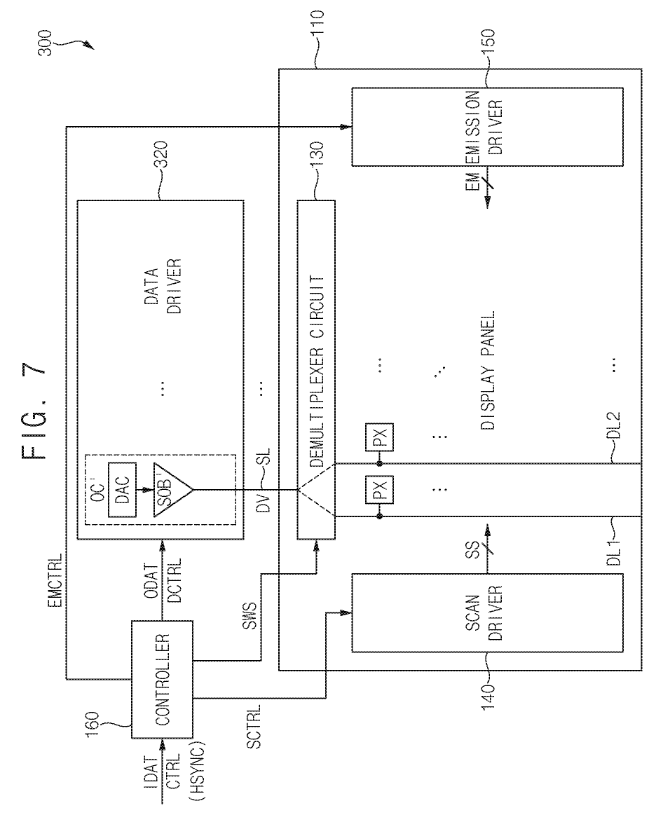

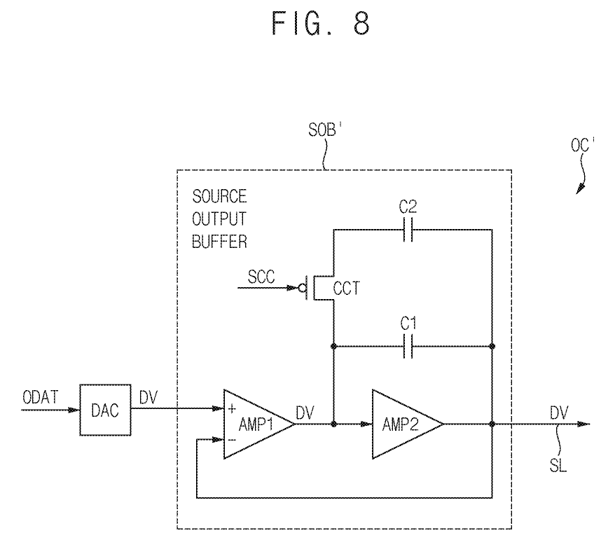

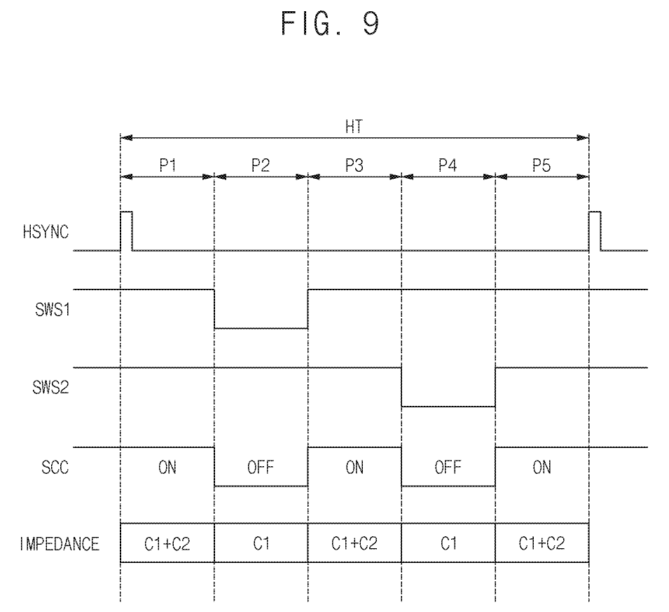

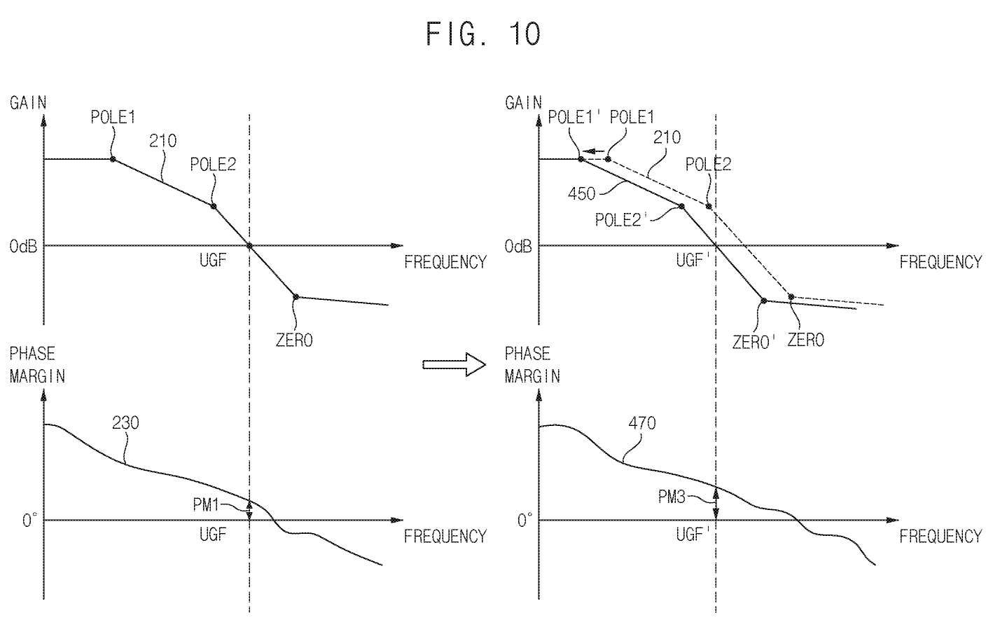

FIG. 7 is a block diagram illustrating a display device according to some embodiments. FIG. 8 is a circuit diagram illustrating an example of an output channel of a data driver according to some embodiments. FIG. 9 is a timing diagram illustrating an example of an impedance of a source output buffer in a display device according to some embodiments. FIG. 10 is a diagram illustrating an example of a phase margin of a source output buffer in a display device that does not include a zero control circuit, and an example of a phase margin of a source output buffer in a display device according to some embodiments.

Referring to FIGS. 7 and 8, a display device 300 according to some embodiments may include a display panel 110, a data driver 320, a demultiplexer circuit 130, a scan driver 140, an emission driver 150, and a controller 160. Each output channel OC’ of the data driver 320 may include a digital-to-analog converter DAC and a source output buffer SOB’. The source output buffer SOB’ may control an impedance of the source output buffer SOB’ in response to a capacitance control signal SCC. The display device 300 of FIG. 7 may have the same or substantially the same configuration and the same or substantially the same operation as those of the display device 100 described above with reference to FIG. 1, except that each output channel OC’ may not include the zero control circuit ZCC, and the source output buffer SOB’ may control the impedance of the source output buffer SOB’.

As illustrated in FIG. 8, the output channel OC’ may include the digital-to-analog converter DAC that converts output image data ODAT into a data voltage DV, and the source output buffer SOB’ that outputs the data voltage DV. The source output buffer SOB’ may control the impedance of the source output buffer SOB’ in response to the capacitance control signal SCC. In more detail, the source output buffer SOB’ may include a first amplifier AMP1, a second amplifier AMP2 having an input terminal connected to an output terminal of the first amplifier AMP1, a first capacitor C1 connected between the input terminal of the second amplifier AMP2 and an output terminal of the second amplifier AMP2, a second capacitor C2 connected to the output terminal of the second amplifier AMP2, and a capacitance control transistor CCT connected in series with the second capacitor C2 between the input terminal of the second amplifier AMP2 and the output terminal of the second amplifier AMP2 to be turned on in response to the capacitance control signal SCC. The first amplifier AMP1 may include a non-inverting input terminal that receives the data voltage DV from the digital-to-analog converter DAC, and an inverting input terminal connected to the output terminal of the second amplifier AMP2. Thus, the second capacitor C2 may be selectively connected between the input terminal and the output terminal of the second amplifier AMP2. In some embodiments, capacitances of the first and second capacitors C1 and C2 that are connected between the input terminal and the output terminal of the second amplifier AMP2 may be increased by the second amplifier AMP2, and the first and second capacitors C1 and C2 may be referred to as Miller capacitors.

In the display device 300 according to some embodiments, the capacitance control signal SCC may have an on-level (e.g., a high level) during a period in which the output channel OC’ is not connected to data lines DL1 and DL2, and the source output buffer SOB’ may increase the impedance of the source output buffer SOB’ in response to the capacitance control signal SCC having the on-level. In some embodiments, during the period in which the output channel OC’ is not connected to the data lines DL1 and DL2, the second capacitor C2 may be connected between the input terminal and the output terminal of the second amplifier AMP2, a dominant pole (e.g., a dominant pole point) of the source output buffer SOB’ may be shifted toward a lower frequency, a phase margin of the source output buffer SOB’ may be increased, and a possibility of an oscillation of the source output buffer SOB’ may be reduced.

For example, as illustrated in FIG. 9, a horizontal time HT defined by a horizontal synchronization signal HSYNC may include a first period P1 in which both first and second switching signals SWS1 and SWS2 have an off-level (e.g., a high level), a second period P2 in which the first switching signal SWS1 has an on-level (e.g., a low level) and the second switching signal SWS2 has the off-level, a third period P3 in which both the first and second switching signals SWS1 and SWS2 have the off-level, a fourth period P4 in which the first switching signal SWS1 has the off-level and the second switching signal SWS2 has the on-level, and a fifth period P5 in which both the first and second switching signals SWS1 and SWS2 have the off-level. The demultiplexer circuit 130 may connect the output channel OC’ to the first data line DL1 or the second data line DL2 in response to the first switching signal SWS1 or the second switching signal SWS2 having the on-level in the second and fourth periods P2 and P4, and may not connect the output channel OC’ to the data lines DL1 and DL2 in the first, third, and fifth periods P1, P3, and P5.

The capacitance control signal SCC may have an on-level ON (e.g., a high level) in the first, third, and fifth periods P1, P3, and P5, and an off-level OFF (e.g., a low level) in the second and fourth periods P2 and P4. Thus, in the second and fourth periods P2 and P4, the capacitance control transistor CCT may be turned off in response to the capacitance control signal SCC having the off-level OFF, and the second capacitor C2 may not be connected to the input terminal of the second amplifier AMP2. Accordingly, in the second and fourth periods P2 and P4 in which the data voltage DV is provided to the pixel PX, the impedance IMPEDANCE of the source output buffer SOB’ may not be increased by the second capacitor C2, and the settling time of the source output buffer SOB’ may not be increased.

In the first, third, and fifth periods P1, P3, and P5, the capacitance control transistor CCT may be turned on in response to the capacitance control signal SCC having the on-level ON, and the second capacitor C2 may be connected to the input terminal of the second amplifier AMP2. Thus, in the first, third, and fifth periods P1, P3, and P5 in which the output channel OC’ is not connected to the data lines DL1 and DL2, the impedance IMPEDANCE of the source output buffer SOB’ may be increased by the second capacitor C2. In some embodiments, the first capacitor C1 and the second capacitor C2 may have the same or substantially the same capacitance as each other. In this case, in the first, third, and fifth periods P1, P3, and P5, the capacitance of a capacitor connected between the input terminal and the output terminal of the second amplifier AMP2 may be doubled. Further, when the impedance IMPEDANCE of the source output buffer SOB’ increases, the dominant pole of the source output buffer SOB’ may be shifted toward a lower frequency, and the phase margin of the source output buffer SOB’ may be increased.

FIG. 10 illustrates, in the first, third, and fifth periods P1, P3, and P5 in which the output channel OC’ is not connected to the data lines DL1 and DL2, a graph 210 of a gain of a source output buffer SOB according to a frequency in a display device in which the source output buffer SOB does not include the second capacitor C2 and the capacitance control transistor CCT, a graph 230 of a phase margin of the source output buffer SOB according to the frequency in the display device in which the source output buffer SOB does not include the second capacitor C2 and the capacitance control transistor CCT, a graph 450 of a gain of the source output buffer SOB’ according to the frequency in the display device 300 according to some embodiments, and a graph 470 of a phase margin of the source output buffer SOB’ according to the frequency in the display device 300 according to some embodiments. In the display device 300 according to some embodiments, because the impedance IMPEDANCE of the source output buffer SOB’ is increased by the second capacitor C2 in the first, third, and fifth periods P1, P3, and P5 in which the output channel OC’ is not connected to the data lines DL1 and DL2, the dominant pole (e.g., a first pole POLE1’) of the source output buffer SOB’ may be shifted toward a lower frequency compared with that of a first pole POLE1 of the source output buffer SOB that does not include the second capacitor C2 and the capacitance control transistor CCT. In some embodiments, as illustrated in FIG. 10, a second pole POLE2’ and a zero ZERO’ of the source output buffer SOB’ may also be shifted toward a lower frequency compared with that of a second pole POLE2 and a zero ZERO of the source output buffer SOB that does not include the second capacitor C2 and the capacitance control transistor CCT, but the present disclosure is not limited thereto. If (e.g., when) the dominant pole (e.g., the first pole POLE1’) of the source output buffer SOB’ is shifted toward a lower frequency, a phase margin PM3 of the source output buffer SOB’ at a unit gain frequency UGF’ may be increased from a phase margin PM1 of the source output buffer SOB that does not include the second capacitor C2 and the capacitance control transistor CCT. Therefore, in the display device 300 according to some embodiments, because the source output buffer SOB’ has the increased phase margin PM3, a possibility of the oscillation of the source output buffer SOB’ may be reduced, and the stability of the data driver 320 may be improved.

As described above, in the display device 300 according to some embodiments, the source output buffer SOB’ may control the impedance IMPEDANCE of the source output buffer SOB’ in response to the capacitance control signal SCC. Accordingly, without increasing the settling time of the source output buffer SOB’, the phase margin of the source output buffer SOB’ may be improved, the possibility of the oscillation of the source output buffer SOB’ may be reduced, and the stability of the data driver 320 may be improved.

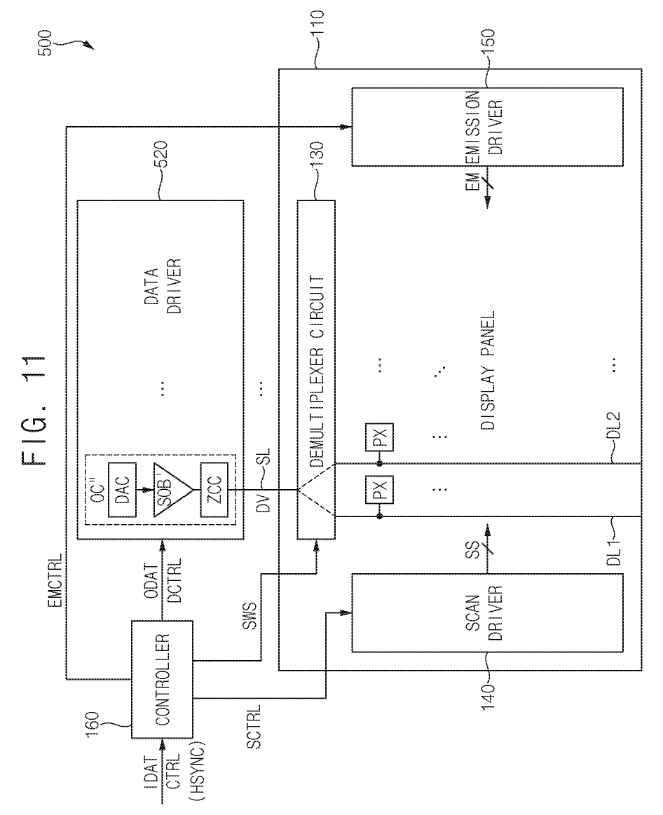

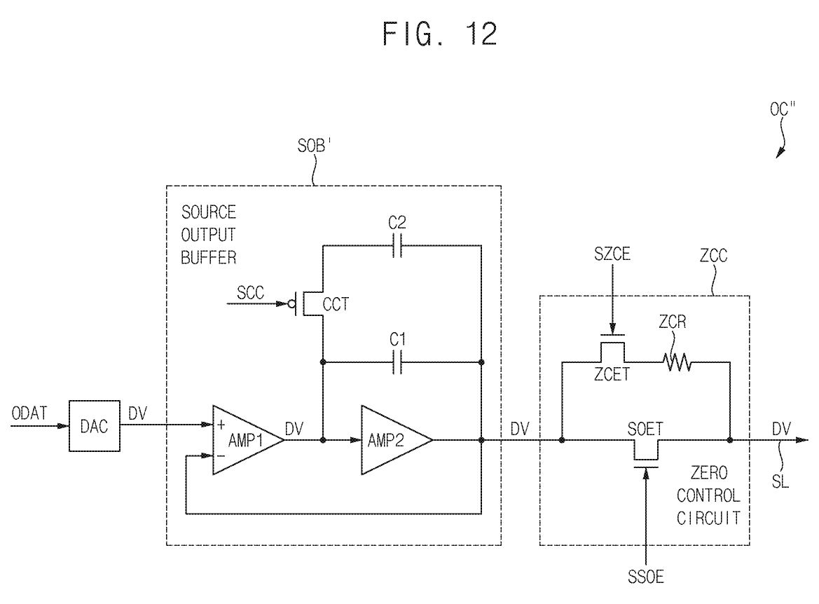

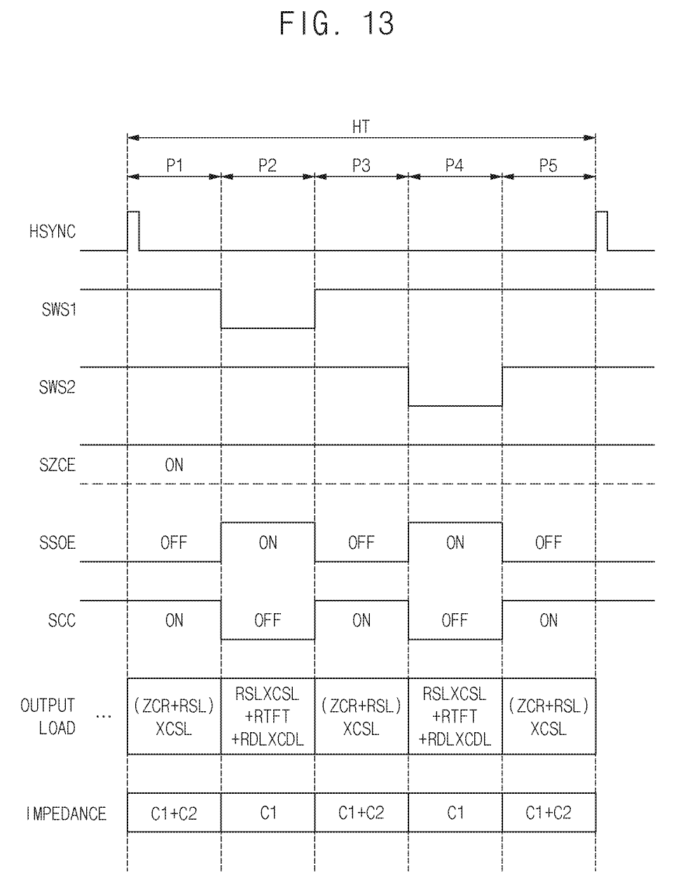

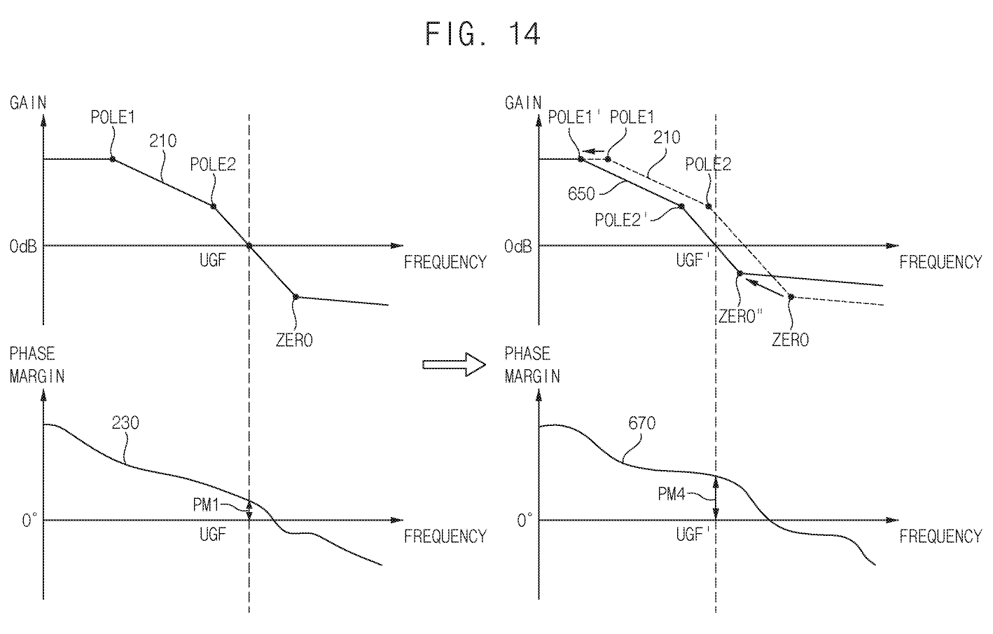

FIG. 11 is a block diagram illustrating a display device according to some embodiments. FIG. 12 is a circuit diagram illustrating an example of an output channel of a data driver according to some embodiments. FIG. 13 is a timing diagram illustrating an example of an output load and an impedance of a source output buffer in a display device according to some embodiments. FIG. 14 is a diagram illustrating an example of a phase margin of a source output buffer in a display device that does not include a zero control circuit, and an example of a phase margin of a source output buffer in a display device according to some embodiments.

Referring to FIGS. 11 and 12, a display device 500 according to some embodiments may include a display panel 110, a data driver 520, a demultiplexer circuit 130, a scan driver 140, an emission driver 150, and a controller 160. Each output channel OC’’ of the data driver 520 may include a digital-to-analog converter DAC, a source output buffer SOB’, and a zero control circuit ZCC. The source output buffer SOB’ may control an impedance of the source output buffer SOB’ in response to a capacitance control signal SCC. The display device 500 of FIG. 11 may have the same or substantially the same configuration and the same or substantially the same operation as those of the display device 100 described above with reference to FIG. 1 or the display device 300 described above with reference to FIG. 7, except that each output channel OC’’ may include the zero control circuit ZCC that controls an output load of the source output buffer SOB’, and the source output buffer SOB’ may control the impedance of the source output buffer SOB’.

As illustrated in FIG. 12, the output channel OC’’ may include the digital-to-analog converter DAC, the source output buffer SOB’, and the zero control circuit ZCC. The source output buffer SOB’ may include a first amplifier AMP1, a second amplifier AMP2, a first capacitor C1, a second capacitor C2, and a capacitance control transistor CCT. The zero control circuit ZCC may include a source output enable transistor SOET, a zero control resistor ZCR, and a zero control enable transistor ZCET. The source output buffer SOB’ may control the impedance of the source output buffer SOB’ by selectively connecting the second capacitor C2 in response to the capacitance control signal SCC. The zero control circuit ZCC may enable a function of the zero control circuit ZCC by turning on the zero control enable transistor ZCET in response to the zero control enable signal SZCE, and may selectively apply (e.g., add) the zero control resistor ZCR to the output load of the source output buffer SOB’ by turning on or off the source output enable transistor SOET in response to the source output enable signal SSOE.

For example, as illustrated in FIG. 13, in second and fourth periods P2 and P4 in which a data voltage DV is provided to a pixel PX, the capacitance control signal SCC may have an off-level OFF, the source output enable transistor SOET may have an on-level ON, the impedance IMPEDANCE of the source output buffer SOB’ may not be increased by the second capacitor C2, the zero control resistor ZCR may not be applied (e.g., added) to the output load OUTPUT LOAD of the source output buffer SOB’, and a settling time of the source output buffer SOB’ may not be increased. In first, third, and fifth periods P1, P3, and P5 in which the output channel OC’’ is not connected to the data lines DL1 and DL2, the capacitance control signal SCC may have the on-level ON, the source output enable transistor SOET may have the off-level OFF, the impedance IMPEDANCE of the source output buffer SOB’ may be increased by the second capacitor C2, the zero control resistor ZCR may be applied (e.g., added) to the output load OUTPUT LOAD of the source output buffer SOB’, a dominant pole and a zero of the source output buffer SOB’ may be shifted toward a lower frequency, a phase margin of the source output buffer SOB’ may be increased, and a possibility of an oscillation of the source output buffer SOB’ may be reduced.

FIG. 14 illustrates, in the first, third, and fifth periods P1, P3, and P5 in which the output channel OC’’ is not connected to the data lines DL1 and DL2, a graph 210 of a gain of a source output buffer SOB according to a frequency in a display device in which the output channel OC’’ does not include the zero control circuit ZCC and the source output buffer SOB does not include the second capacitor C2 and the capacitance control transistor CCT, a graph 230 of a phase margin of the source output buffer SOB according to the frequency in the display device in which the output channel OC’’ does not include the zero control circuit ZCC and the source output buffer SOB does not include the second capacitor C2 and the capacitance control transistor CCT, a graph 650 of a gain of the source output buffer SOB’ according to the frequency in the display device 500 according to some embodiments, and a graph 670 of a phase margin of the source output buffer SOB’ according to the frequency in the display device 500 according to some embodiments. In the display device 500 according to some embodiments, in the first, third, and fifth periods P1, P3, and P5 in which the output channel OC’’ is not connected to the data lines DL1 and DL2, the impedance IMPEDANCE of the source output buffer SOB’ may be increased by the second capacitor C2, and thus, the dominant pole (e.g., a first pole POLE1’) of the source output buffer SOB’ may be shifted toward a lower frequency compared with that of a first pole POLE1 of the source output buffer SOB that does not include the second capacitor C2 and the capacitance control transistor CCT. In the first, third, and fifth periods P1, P3, and P5, because the zero control resistor ZCR is applied (e.g., added) to the output load OUTPUT LOAD of the source output buffer SOB’, the zero ZERO’’ of the source output buffer SOB’ may be further shifted toward a lower frequency compared with that of a comparative zero ZERO. Accordingly, a phase margin PM4 of the source output buffer SOB’ at the unit gain frequency UGF’ may be further increased from a comparative phase margin PM1. Therefore, in the display device 500 according to some embodiments, because the source output buffer SOB’ has the increased phase margin PM4, a possibility of the oscillation of the source output buffer SOB’ may be reduced, and the stability of the data driver 520 may be improved.

As described above, in the display device 500 according to some embodiments, the output channel OC’’ of the data driver 520 may include the zero control circuit ZCC that selectively applies the zero control resistor ZCR to the output load OUTPUT LOAD of the source output buffer SOB’ in response to the zero control enable signal SZCE and the source output enable signal SSOE, and the source output buffer SOB’ may control the impedance IMPEDANCE of the source output buffer SOB’ in response to the capacitance control signal SCC. Accordingly, without increasing the settling time of the source output buffer SOB’, the phase margin of the source output buffer SOB’ may be improved, the possibility of the oscillation of the source output buffer SOB’ may be reduced, and the stability of the data driver 520 may be improved.

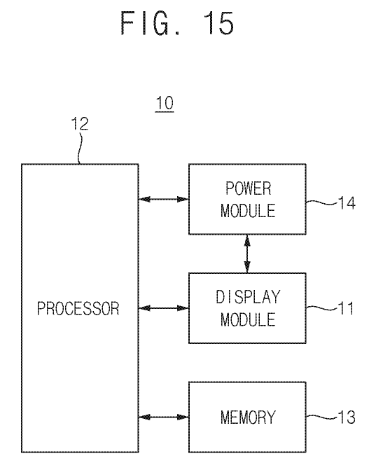

FIG. 15 is a block diagram illustrating an electronic device according to some embodiments.

Referring to FIG. 15, an electronic device 10 according to some embodiments may include a display module 11, a processor 12, a memory 13, and a power module 14.

The processor 12 may include at least one of a central processing unit (“CPU”), an application processor (“AP”), a graphics processing unit (“GPU”), a communication processor (“CP”), an image signal processor (“ISP”), and/or a controller.

The memory 13 may store data information for an operation of the processor 12 or the display module 11. When the processor 12 executes an application stored in the memory 13, an image data signal and/or an input control signal may be transferred to the display module 11, and the display module 11 may output image information through a display screen by processing the received signal.

The power module 14 may include a power supply, such as a power adapter or a battery device, and a power conversion module that converts power supplied by the power supply to generate power for an operation of the electronic device 10.

At least one of the components of the electronic device 10 described above may be included in the display device described above according to some embodiments. Further, some of the individual modules functionally included in one module may be included in the display device, and other modules may be provided separately from the display device. For example, the display device may include the display module 11, and the processor 12, the memory 13, and the power module 14 may be provided in the form of other devices within the electronic device 10 other than the display device.

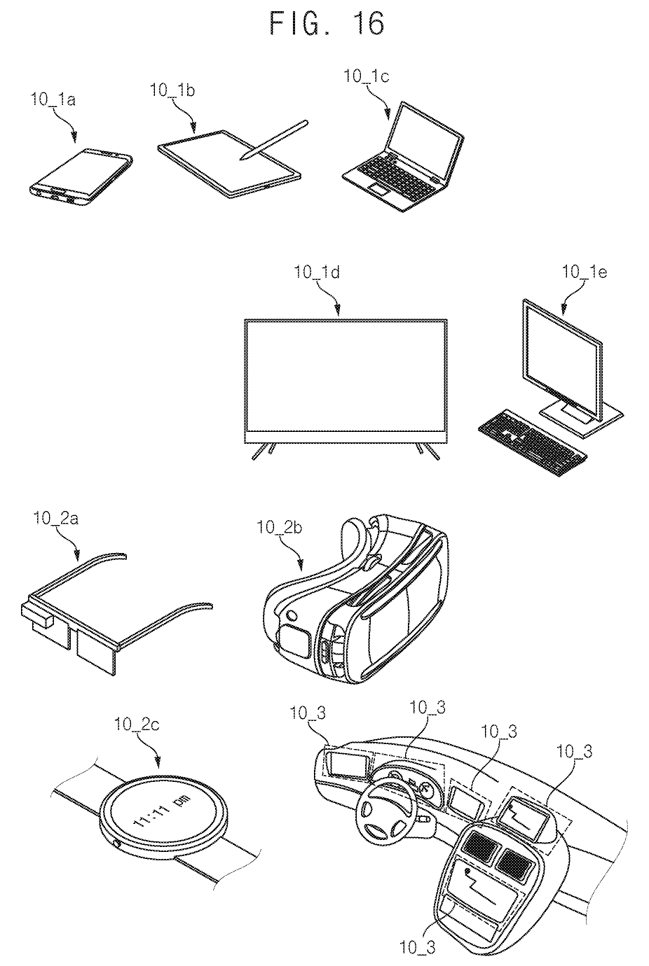

FIG. 16 is a schematic diagram illustrating various electronic devices according to some embodiments.

Referring to FIG. 16, various electronic devices to which the display device according to some embodiments may be applied may include not only image display electronic devices, such as a smart phone 10_1a, a tablet personal computer (“PC”) 10_1b, a laptop 10_1c, a television (“TV”) 10_1d, and a desk monitor 10_1e, but may also include wearable electronic devices including display modules, such as smart glasses 10_2a, a head mounted display 10_2b, and a smart watch 10_2c, and vehicle electronic devices 10_3 including display modules, such as a center information display (“CID”) arranged on an instrument panel, a center fascia, and a dashboard of an automobile, and a room mirror display.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A display device comprising:
a display panel comprising a plurality of data lines, and a plurality of pixels connected to the plurality of data lines;
a data driver comprising an output channel configured to output a data voltage; and
a demultiplexer circuit configured to selectively connect the output channel to two or more data lines among the plurality of data lines in response to first and second switching signals,
wherein the output channel comprises:
a source output buffer configured to output the data voltage; and
a zero control circuit configured to selectively apply a zero control resistor to an output load of the source output buffer in response to a zero control enable signal and a source output enable signal.

2. The display device of claim 1, wherein the zero control circuit is configured to apply the zero control resistor to the output load of the source output buffer during a period in which the output channel is not connected to the two or more data lines.

3. The display device of claim 1, wherein the zero control circuit is configured to shift a zero of the source output buffer to a lower frequency during a period in which the output channel is not connected to the two or more data lines.

4. The display device of claim 1, wherein the zero control circuit comprises:
a source output enable transistor connected between an output terminal of the source output buffer and the demultiplexer circuit, and configured to be turned on in response to the source output enable signal;
the zero control resistor connected to the demultiplexer circuit; and
a zero control enable transistor connected in series with the zero control resistor between the output terminal of the source output buffer and the demultiplexer circuit, and configured to be turned on in response to the zero control enable signal.

5. The display device of claim 4, wherein the plurality of pixels is located in a plurality of pixel rows, and a horizontal time for each of the plurality of pixel rows comprises:
a first period in which both the first switching signal and the second switching signal have an off-level;
a second period in which the first switching signal has an on-level and the second switching signal has the off-level;
a third period in which both the first switching signal and the second switching signal have the off-level;
a fourth period in which the first switching signal has the off-level and the second switching signal has the on-level; and
a fifth period in which both the first switching signal and the second switching signal have the off-level.

6. The display device of claim 5, wherein the plurality of data lines comprises a first data line and a second data line,
wherein the demultiplexer circuit comprises:
a first switch configured to connect the output channel to the first data line in response to the first switching signal having the on-level in the second period; and
a second switch configured to connect the output channel to the second data line in response to the second switching signal having the on-level in the fourth period, and
wherein the demultiplexer circuit is configured to not connect the output channel to the first and second data lines in the first, third, and fifth periods.

7. The display device of claim 5, wherein the zero control enable signal has an on-level in the first, second, third, fourth, and fifth periods, and
wherein the source output enable signal has an off-level in the first, third, and fifth periods, and has the on-level in the second and fourth periods.

8. The display device of claim 7, wherein, in the second and fourth periods, the zero control enable transistor is configured to be turned on, and the zero control resistor is configured to not be applied to the output load of the source output buffer, and
wherein, in the first, third, and fifth periods, the zero control enable transistor is configured to be turned off, and the zero control resistor is configured to be applied to the output load of the source output buffer.

9. The display device of claim 1, wherein the source output buffer comprises:
a first amplifier;
a second amplifier comprising an input terminal connected to an output terminal of the first amplifier; and
a first capacitor connected between the input terminal of the second amplifier and an output terminal of the second amplifier.

10. The display device of claim 1, wherein the source output buffer is configured to control an impedance of the source output buffer in response to a capacitance control signal.

11. The display device of claim 10, wherein the source output buffer is configured to increase the impedance of the source output buffer during a period in which the output channel is not connected to the two or more data lines.

12. The display device of claim 10, wherein the source output buffer is configured to shift a dominant pole of the source output buffer to a lower frequency during a period in which the output channel is not connected to the two or more data lines.

13. The display device of claim 10, wherein the source output buffer comprises:
a first amplifier;
a second amplifier comprising an input terminal connected to an output terminal of the first amplifier;
a first capacitor connected between the input terminal of the second amplifier and an output terminal of the second amplifier;
a second capacitor connected to the output terminal of the second amplifier; and
a capacitance control transistor connected in series with the second capacitor between the input terminal of the second amplifier and the output terminal of the second amplifier, and configured to be turned on in response to the capacitance control signal.

14. The display device of claim 13, wherein the plurality of pixels is located in a plurality of pixel rows, and a horizontal time for each of the plurality of pixel rows comprises:
a first period in which both the first switching signal and the second switching signal have an off-level;
a second period in which the first switching signal has an on-level and the second switching signal has the off-level;
a third period in which both the first switching signal and the second switching signal have the off-level;
a fourth period in which the first switching signal has the off-level and the second switching signal has the on-level; and
a fifth period in which both the first switching signal and the second switching signal have the off-level,
wherein the capacitance control signal has the on-level in the first, third, and fifth periods, and has the off-level in the second and fourth periods, and
wherein the capacitance control transistor is configured to connect the second capacitor to the input terminal of the second amplifier in response to the capacitance control signal having the on-level in the first, third, and fifth periods.

15. A display device comprising:
a display panel comprising a plurality of data lines, and a plurality of pixels connected to the plurality of data lines;
a data driver comprising an output channel configured to output a data voltage; and
a demultiplexer circuit configured to selectively connect the output channel to two or more data lines among the plurality of data lines in response to first and second switching signals,
wherein the output channel comprises a source output buffer configured to output the data voltage, and
wherein the source output buffer is configured to control an impedance of the source output buffer in response to a capacitance control signal.

16. The display device of claim 15, wherein the source output buffer is configured to increase the impedance of the source output buffer during a period in which the output channel is not connected to the two or more data lines.

17. The display device of claim 15, wherein the source output buffer is configured to shift a dominant pole of the source output buffer to a lower frequency during a period in which the output channel is not connected to the two or more data lines.

18. The display device of claim 15, wherein the source output buffer comprises:
a first amplifier;
a second amplifier comprising an input terminal connected to an output terminal of the first amplifier;
a first capacitor connected between the input terminal of the second amplifier and an output terminal of the second amplifier;
a second capacitor connected to the output terminal of the second amplifier; and
a capacitance control transistor connected in series with the second capacitor between the input terminal of the second amplifier and the output terminal of the second amplifier, and configured to be turned on in response to the capacitance control signal.

19. The display device of claim 15, wherein the output channel further comprises:
a zero control circuit configured to selectively apply a zero control resistor to an output load of the source output buffer in response to a zero control enable signal and a source output enable signal, and
wherein the zero control circuit comprises:
a source output enable transistor connected between an output terminal of the source output buffer and the demultiplexer circuit, and configured to be turned on in response to the source output enable signal;
the zero control resistor connected to the demultiplexer circuit; and
a zero control enable transistor connected in series with the zero control resistor between the output terminal of the source output buffer and the demultiplexer circuit, and configured to be turned on in response to the zero control enable signal.

20. An electronic device comprising:
a processor configured to provide input image data; and
a display device configured to receive the input image data from the processor, and display an image based on the input image data, the display device comprising:
a display panel comprising a plurality of data lines, and a plurality of pixels connected to the plurality of data lines;
a data driver comprising an output channel configured to output a data voltage; and
a demultiplexer circuit configured to selectively connect the output channel to two or more data lines among the plurality of data lines in response to first and second switching signals,
wherein the output channel comprises:
a source output buffer configured to output the data voltage; and
a zero control circuit configured to selectively apply a zero control resistor to an output load of the source output buffer in response to a zero control enable signal and a source output enable signal, and
wherein the source output buffer is configured to control an impedance of the source output buffer in response to a capacitance control signal.
